(19) United States
(12) Patent Application Publication
(10) Pub. No.: US 2026/0049021 A1
(43) Pub. Date: Feb. 19, 2026

(54) METHOD FOR PRODUCING AN ANTI-RESONANT HOLLOW-CORE FIBER

(71) Applicant: Heraeus Quarzglas GmbH & Co. KG, Hanau (DE)

(72) Inventors: Manuel ROSENBERGER, Kleinostheim (DE); Kay SCHUSTER, Bitterfeld-Wolfen (DE)

(21) Appl. No.: 19/296,266

(22) Filed: Aug. 11, 2025

(30) Foreign Application Priority Data
Aug. 14, 2024 (EP) 24194439.6

(51) Int. Cl. C03B 37/027

(52) U.S. Cl. CPC C03B 37/02781; C03B 2203/16

(57) ABSTRACT

A method for producing an anti-resonant hollow-core fiber having an outer diameter of less than 500 mm, having the steps of: providing a sheath tube, which comprises a sheath tube inner bore and a sheath tube longitudinal axis along which a sheath tube wall extends, the sheath tube wall being delimited by a sheath tube inner face and a sheath tube outer face; preparing a number of anti-resonance units, each comprising an ARU outer tube; inserting at least parts of the anti-resonance units into the sheath tube inner bore; and creating a hollow-core assembly comprising the sheath tube and the anti-resonance units by at least partially connecting the anti-resonance units to the sheath tube inner face; preparing a jacket tube, which comprises a jacket tube inner bore and a jacket tube longitudinal axis along which a jacket tube wall extends.

### CROSS-REFERENCE TO RELATED APPLICATION

This application claims priority pursuant to 35 U.S.C. 119(a) to European Patent Office Application No. 24194439.6, filed Aug. 14, 2024, which application is incorporated herein by reference in its entirety.

### FIELD

The invention relates to a method for producing an anti-resonant hollow-core fiber.

### BACKGROUND

Hollow-core fibers have a core that comprises an evacuated cavity filled with gas or liquid. In hollow-core fibers, the interaction of light with the glass is lower than in solid-core fibers. The refractive index of the core is smaller than that of the surrounding cladding, so that light transmission by total reflection is not possible. Depending on the physical mechanism of light transmission, hollow-core fibers are divided into “photonic band gap fibers” and “anti-resonance reflection fibers”.

In the embodiment of the hollow-core fiber referred to as “anti-resonant hollow-core fiber” (ARHCF), the hollow core region is surrounded by an inner cladding region in which what are known as anti-resonance units (also known as “anti-resonant elements” or “ARUs”) are arranged. The walls of the anti-resonance units, which are distributed uniformly around the hollow core, can act as Fabry-Perot cavities operated in anti-resonance, which reflect the incident light and thereby enable waveguiding in the fiber core.

This technology promises a hollow-core fiber with low optical attenuation, a very broad transmission spectrum (also in the UV or IR wavelength range) and low latency during data transmission.

From WO 2022 157179 A1, an anti-resonant hollow-core fiber is known in which the hollow core is surrounded by an inner cladding with anti-resonance units. These anti-resonance units have an ARU outer tube and an ARU inner tube inserted therein.

WO 2018/169487 A1 discloses a method for producing a preform for hollow-core fibers, in which method a first casing region comprises a plurality of rods and a second casing region comprises a plurality of tubes surrounded by an outer sheath tube. The rods, tubes, and sheath tube are joined to form a preform by means of the “stack-and-draw” technique.

The publication “Hollow-Core Fiber Technology: The Rising of Gas Photonics” by Benoit Debord (in Fibers, 2019, 7, 16) presents a model that can simulate tubular anti-resonant hollow-core fiber draws and that can predict the drawing parameters and geometry of the fiber.

For industrial use, anti-resonant hollow-core fibers that have low attenuation are required. Furthermore, an anti-resonant hollow-core fiber is required that can be produced easily and on a large scale. This is the only way to bring the costs of anti-resonant hollow-core fibers within reasonable limits. It is important to note that methods for producing anti-resonant hollow-core fibers that yield good results on a laboratory scale are not necessarily suitable for large-scale use.

### SUMMARY OF THE INVENTION

An aim of the invention is to provide a method for producing anti-resonant hollow-core fibers which overcomes the above-mentioned disadvantages.

I In particular, it is an object of the invention to provide a method for producing anti-resonant hollow-core fibers in which the anti-resonant units are less deformed.

In particular, it is an object of the invention to provide a method for producing anti-resonant hollow-core fibers in which the anti-resonant units are exposed to the lowest possible temperature during a drawing step.

The invention relates to a method for producing an anti-resonant hollow-core fiber having an outer diameter of less than 500 mm, having the steps of: providing a sheath tube, which comprises a sheath tube inner bore and a sheath tube longitudinal axis along which a sheath tube wall extends, the sheath tube wall being delimited by a sheath tube inner face and a sheath tube outer face; preparing a number of anti-resonance units, each comprising an ARU outer tube; inserting at least parts of the anti-resonance units into the sheath tube inner bore; creating a hollow-core assembly comprising the sheath tube and the anti-resonance units by at least partially connecting the anti-resonance units to the sheath tube inner face; preparing a jacket tube, which comprises a jacket tube inner bore and a jacket tube longitudinal axis along which a jacket tube wall extends, the jacket tube wall being delimited by a jacket inner face and a jacket outer face; introducing at least parts of the hollow-core assembly into the jacket tube inner bore; and, drawing the hollow-core fiber from the jacket tube and the hollow-core assembly by means of a hot-forming process.

According to the invention, it is provided that in the step of drawing the hollow-core fiber, the sheath tube has a sheath tube diameter of at least 8 mm; the jacket tube has a jacket tube diameter of at least 25 mm; and, a ratio of a jacket tube cross-sectional area of the jacket tube wall to a sheath tube cross-sectional area of the sheath tube wall lies within the interval.

A contribution to the at least partial fulfillment of at least one of the aforementioned objects is made by the features of the independent claims. The dependent claims provide preferred embodiments that contribute to the at least partial fulfillment of at least one of the objects.

The following embodiments contribute at least partially to fulfilling at least one of the aforementioned objects:

A first embodiment of the method for producing an anti-resonant hollow-core fiber having an outer diameter of less than 500 mm, comprises the steps of:
providing a sheath tube which comprises a sheath tube inner bore and a sheath tube longitudinal axis along which a sheath tube wall extends which is delimited by a sheath tube inner face and a sheath tube outer face,
preparing a number of anti-resonance units, each comprising an ARU outer tube,
inserting at least parts of the anti-resonance unit into the sheath tube inner bore,
creating a hollow-core assembly comprising the sheath tube and the anti-resonance units by at least partially connecting the anti-resonance units to the sheath tube inner face,
preparing a jacket tube which comprises a jacket tube inner bore and a jacket tube longitudinal axis along which a jacket tube wall extends, the jacket tube wall being delimited by a jacket inner face and a jacket outer face,
introducing at least parts of the hollow-core assembly into the jacket tube inner bore,
drawing the hollow-core fiber from the jacket tube and the hollow-core assembly by means of a hot-forming process.

It is provided that in the step of drawing the hollow-core fiber:
the sheath tube has a sheath tube diameter of at least 8 mm,
the jacket tube has a jacket tube diameter of at least 25 mm, and
a ratio of a jacket tube cross-sectional area of the jacket tube wall to a sheath tube cross-sectional area of the sheath tube wall lies within the interval [5; 40].

A further embodiment of the method is wherein the ratio of the jacket tube cross-sectional area to the sheath tube cross-sectional area has at least one of the following features:
it is less than or equal to 37, in particular less than or equal to 35, in particular less than or equal to 30;
it is greater than or equal to 9, in particular greater than or equal to 12, in particular greater than or equal to 15, in particular greater than or equal to 20.

This embodiment is the second embodiment of the method, which in particular depends on the first embodiment of the method.

A further embodiment of the method is wherein the anti-resonant hollow-core fiber has an outer diameter of less than 450 mm, in particular less than 400 mm, in particular less than 300 mm, in particular less than 270 mm, in particular less than 250 mm.

This embodiment is the third embodiment of the method, which in particular depends on the first or second embodiment of the method.

A further embodiment of the method is wherein a core radius R_Faser comprises at least one of the following features:
it is less than or equal to 26 mm, in particular less than or equal to 23 mm, in particular less than or equal to 20 mm; and
it is greater than or equal to 10 mm, in particular greater than or equal to 12 mm, in particular greater than or equal to 14 mm.

This embodiment is the fourth embodiment of the method, which in particular depends on the first to third embodiments of the method.

A further embodiment of the method is wherein the sheath tube comprises at least one of the following features:
the sheath tube diameter is less than or equal to 100 mm, less than or equal to 90 mm, less than or equal to 75 mm, less than or equal to 50 mm;
the sheath tube diameter is greater than or equal to 10 mm, greater than or equal to 15 mm, greater than or equal to 20 mm;
the sheath tube wall has a wall thickness of more than 2 mm, more than 3 mm, more than 5 mm, more than 7.5 mm;
the sheath tube wall has a wall thickness of less than 25 mm, less than 20 mm, less than 15 mm;
the sheath tube has a sheath tube length of at least 1 m;
a magnitude of the wall thickness of the sheath tube wall varies over the sheath tube length by less than 10%, in particular 5%, in particular 3% of the wall thickness.

This embodiment is the fifth embodiment of the method, which in particular depends on the first to fourth embodiments of the method.

A further embodiment of the method is wherein the ARU outer tube has an ARU inner tube inserted therein.

This embodiment is the sixth embodiment of the method, which in particular depends on the first to fifth embodiments of the method.

A further embodiment of the method is wherein the hollow-core assembly has three, four, five, six, seven or eight anti-resonance units.

This embodiment is the seventh embodiment of the method, which in particular depends on the first to sixth embodiments of the method.

A further embodiment of the method is wherein the at least partial connection of the anti-resonance units to the sheath tube inner face comprises at least one of the following features:
connecting in a second hot-forming process, in particular selected from at least one of elongating and collapsing;
integrally connecting the anti-resonance units to the sheath tube inner face along a connection seam;
integrally connecting, at points, the anti-resonance units to parts of the sheath tube inner face.

This embodiment is the eighth embodiment of the method, which in particular depends on the first to seventh embodiments of the method.

A further embodiment of the method is wherein the jacket tube comprises at least one of the following features:
the jacket tube diameter is less than or equal to 290 mm, in particular less than or equal to 220 mm, in particular less than or equal to 180 mm, in particular less than or equal to 150 mm;
the jacket tube diameter is greater than or equal to 50 mm, in particular greater than or equal to 60 mm, in particular greater than or equal to 75 mm, in particular greater than or equal to 85 mm;
the jacket tube wall has a wall thickness of more than 20 mm, in particular more than 30 mm, in particular more than 40 mm, in particular more than 50 mm;
the jacket tube wall has a wall thickness of less than 90 mm, in particular less than 80 mm, in particular less than 70 mm, in particular less than 60 mm;
the jacket tube has a jacket tube length of at least 1 m; and,
a magnitude of the wall thickness of the jacket tube wall varies over the jacket tube length by not more than 10%, in particular 5%, in particular 3% of the wall thickness.

This embodiment is the ninth embodiment of the method, which in particular depends on the first to eighth embodiments of the method.

A further embodiment of the method is wherein the sheath tube length and the jacket tube length, in particular the sheath tube length, the jacket tube length and a length of the anti-resonance units, differ by not more than 15%, in particular 10%, in particular 5%, relative to the jacket tube length.

This embodiment is the tenth embodiment of the method, which in particular depends on the first to ninth embodiments of the method.

A further embodiment of the method is wherein the method comprises at least one of the following features:
a magnitude of the sheath tube cross-sectional area of the sheath tube wall varies over the sheath tube length by not more than 10%, in particular 5%, in particular 3%;
a magnitude of the jacket tube cross-sectional area of the jacket tube wall varies over the jacket tube length by not more than 10%, in particular 5%, in particular 3%; and,
a magnitude of the ratio of the jacket tube cross-sectional area to the sheath tube cross-sectional area varies over the jacket tube length by not more than 10%, in particular 5%, in particular 3%, relative to the jacket tube cross-sectional area.

This embodiment is the eleventh embodiment of the method, which in particular depends on the first to tenth embodiment of the method.

A further embodiment of the method is wherein the method is free of hot forming process steps between the step of introducing and the step of drawing.

This embodiment is the twelfth embodiment of the method, which in particular depends on the first to eleventh embodiment of the method.

A further embodiment of the method is wherein the method is intermediate step-free between the step of introducing and the step of drawing.

This embodiment is the thirteenth embodiment of the method, which in particular depends on the first to twelfth embodiments of the method.

A further embodiment of the method is wherein the step of drawing is performed by means of a hot-forming process selected from at least one of elongating and collapsing.

This embodiment is the fourteenth embodiment of the method, which in particular depends on the first to thirteenth embodiments of the method.

A further embodiment of the method is wherein heat introduced into the jacket tube in the hot-forming process in the step of drawing is subject to at least two heat transfers during transfer between the jacket tube and the sheath tube, in particular that, after the step of introducing, there is a gap between the jacket tube and the hollow-core assembly, so that heat introduced into the jacket tube in particular in the hot-forming process in the step of drawing is subject to at least two heat transfers in the gap.

This embodiment is the fifteenth embodiment of the method, which in particular depends on the first to fourteenth embodiments of the method.

A further embodiment of the method is wherein, when the hollow-core assembly is centrally positioned in the jacket tube inner bore, the gap has at least one of the following features:
a radial size of the gap is less than or equal to 4 mm, in particular less than or equal to 3 mm, in particular less than or equal to 2 mm, in particular less than or equal to 1 mm; and,
the radial size of the gap is greater than or equal to 0.3 mm, in particular greater than or equal to 0.5 mm, in particular greater than or equal to 0.75 mm, in particular greater than or equal to 0.85 mm.

This embodiment is the sixteenth embodiment of the method, which in particular depends on the fifteenth embodiment of the method.

A further embodiment of the method is wherein a first heat transfer coefficient at an outer interface between the gap and the jacket inner face lies within the interval [65; 180] W/(m²*K), in particular within the interval [90; 150] W/(m²*K) for 500-900° C.

This embodiment is the seventeenth embodiment of the method, which in particular depends on at least one of the fifteenth to sixteenth embodiments of the method.

A further embodiment of the method is wherein a second heat transfer coefficient at an inner interface between the gap and the sheath tube outer side lies within the interval [65; 180] W/(m²*K), in particular within the interval [90; 150] W/(m²*K) for 500-900° C.

This embodiment is the eighteenth embodiment of the method, which in particular depends on the fifteenth to seventeenth embodiments of the method.

A further embodiment of the method is wherein the method comprises at least one of the following steps:
coating the hollow-core fiber with at least one layer, in particular a layer comprising light-curing polymer; and,
winding the hollow-core fiber onto a spool.

This embodiment is the nineteenth embodiment of the method, which in particular depends on the first to eighteenth embodiments of the method.

A further embodiment of the method is wherein the hollow-core fiber comprises at least one of the following features:
sheath tube, and/or anti-resonance units, and/or ARU outer tube, and/or ARU inner tube, and/or jacket tube comprises an amorphous solid, in particular a glass, in particular quartz glass;
sheath tube and/or anti-resonance units, and/or ARU outer tube, and/or ARU inner tube, and/or jacket tube consists of an amorphous solid, in particular a glass, in particular quartz glass; and,
at least two of the sheath tube, anti-resonance units, ARU outer tube, ARU inner tube and jacket tube are the same material, comprise or consist of a glass having a refractive index of at least 1.4, 1.4 to 3, or 1.4 to 2.8.

This embodiment is the twentieth embodiment of the method, which in particular depends on the first to nineteenth embodiments of the method.

In the present description, specifications of ranges also contain the values specified as limits. A specification of the type “in the range from X to Y” with respect to a quantity A consequently means that A can take the values X, Y and values between X and Y.

Some of the features described are associated with the term “substantially”. The term “substantially” is to be understood in such a way that, under real conditions and manufacturing techniques, a mathematically exact interpretation of terms, such as “perpendicular”, “diameter” or “parallelism”, can never be given exactly, but only within certain manufacturing error tolerances.

The invention relates to a method for producing an anti-resonant hollow-core fiber with an outer diameter of less than 500 mm, comprising the steps:
providing a sheath tube which comprises a sheath tube inner bore and a sheath tube longitudinal axis along which a sheath tube wall extends which is delimited by a sheath tube inner face and a sheath tube outer face,
preparing a number of anti-resonance units, each comprising an ARU outer tube,
inserting at least parts of the anti-resonance unit into the sheath tube inner bore,
creating a hollow-core assembly comprising the sheath tube and the anti-resonance units by at least partially connecting the anti-resonance units to the sheath tube inner face,
preparing a jacket tube which comprises a jacket tube inner bore and a jacket tube longitudinal axis along which a jacket tube wall extends, the jacket tube wall being delimited by a jacket inner face and a jacket outer face,
introducing at least parts of the hollow-core assembly into the jacket tube inner bore,
drawing the hollow-core fiber from the jacket tube and the hollow-core assembly by means of a hot-forming process.

According to the invention, it is provided that in the step of drawing the hollow-core fiber,
the sheath tube has a sheath tube diameter of at least 8 mm,
the jacket tube has a jacket tube diameter of at least 25 mm, and
a ratio of a jacket tube cross-sectional area of the jacket tube wall to a sheath tube cross-sectional area of the sheath tube wall lies within the interval [5; 40].

The end product of the method according to the invention is an anti-resonant hollow-core fiber with an outer diameter of less than 500 mm. Such hollow-core fibers are used as optical fibers in telecommunications, in data centers.

The reduction in temperature on the sheath tube inner face achieved by the described method results in particular in an increase in the viscosity of the anti-resonance unit, in particular of the ARU inner tubes. The higher stability of the anti-resonance unit in the drawing step ensures smaller fluctuations in the geometric shape of the anti-resonance units in the hollow-core fiber. These fluctuations otherwise lead to deviations in the geometry of the drawn hollow-core fiber from the desired fiber profile. However, even small deviations from the desired fiber profile often lead to a non-linear increase in attenuation. Accordingly, even the smallest deviations from the desired fiber profile have strong consequences. Therefore, the disclosed type of method significantly reduces the variations in the attenuation of the drawn anti-resonant hollow-core fiber.

During the provision step, the sheath tube is prepared. The sheath tube is an elongated hollow body whose length is significantly larger than its diameter. The sheath tube has a sheath tube inner bore and a sheath tube longitudinal axis, along which a sheath tube wall extends which is delimited by a sheath tube inner face and a sheath tube outer face. Due to the tube-like structure, the sheath tube has a hollow core that extends along the sheath tube's longitudinal axis. In particular, the sheath tube can have a length of at least 1 m, in particular 2 m. In one embodiment, the sheath tube comprises or consists of a material which is transparent to a working light of the optical fiber, for example, glass, in particular doped or non-doped quartz glass (SiO₂). Doping allows the adjustment of physical properties, such as the thermal expansion coefficient. Dopants used to lower the viscosity of quartz glass are preferably fluorine, chlorine, and/or hydroxyl groups.

During the preparation step, a number of anti-resonance units are created. The single anti-resonance unit is constructed as a tubular structural element comprising an ARU outer tube. In one embodiment, the anti-resonance units comprise an ARU outer tube and an ARU inner tube inserted therein. In this embodiment, the anti-resonance units can comprise at least two walls which, viewed from the direction of the hollow core, have a negative curvature (convex) or no curvature (flat, straight).

In one embodiment, the anti-resonance unit comprises or consists of a material which is transparent to a working light of the optical fiber, for example, glass, in particular doped or non-doped quartz glass (SiO₂). Doping allows the adjustment of physical properties, such as the thermal expansion coefficient. Dopants used to lower the viscosity of quartz glass are preferably fluorine, chlorine, and/or hydroxyl groups. In one embodiment, the anti-resonance units and the sheath tube are the same material.

The term same material describes the material properties of two parts. The two parts substantially consist of the same chemical substance. The total mass of the different chemical elements in both parts can be less than 1 wt. %, in particular less than 0.5 wt. %, in particular less than 0.1 wt. %. In particular, the chemical composition of the two parts differs by an impurity content of less than 500 ppm by weight, in particular less than 100 ppm by weight, and/or by a dopant content of less than 10,000 ppm by weight, in particular less than 5,000 ppm by weight.

During the insertion step, the anti-resonance units are at least partially inserted into the inner bore of the sheath tube. The aim is for the anti-resonance units to be arranged in the inner bore of the sheath tube.

During the creation step, a hollow-core assembly is produced. Such a hollow-core assembly is also called a cane and includes the sheath tube and the anti-resonance units. The anti-resonance units are connected to the sheath tube inner face, at least partially. Before connecting, the tubular anti-resonance units are inserted into the hollow core of the tubular sheath tube. The anti-resonance units can then be positioned at predetermined target positions in the sheath tube. The at least partial connection of the anti-resonance units to the sheath tube inner face can comprise at least one of the following steps:
connecting in a second hot-forming process, selected from at least one of elongating and collapsing;
integrally connecting the anti-resonance units to the sheath tube inner face along a connection seam; and,
integrally connecting, at points, the anti-resonance units to parts of the sheath tube inner face.

The term same material describes the connection of at least two connecting partners, in which the connecting partners are held together by atomic or molecular forces.

The anti-resonance units on the sheath tube inner face can be connected at points. In one embodiment, the given anti-resonance unit can be integrally connected to the sheath tube inner face only at least two points.

In another embodiment, the given anti-resonance unit can be integrally connected to the sheath tube inner face along a connecting seam. In particular, the connecting seam can run substantially over the length of the sheath tube inner face.

After connection, a longitudinal axis of the given anti-resonance units can be aligned substantially parallel to the sheath tube longitudinal axis. In one embodiment, the longitudinal axis of the anti-resonance units and the sheath tube longitudinal axis can have an angle of −1.5 degrees to 1.5 degrees, preferably of −0.85 degrees to 0.85 degrees, preferably of −0.42 degrees to 0.42 degrees to each other. This parallelism improves the resonance or anti-resonance conditions in the subsequent hollow-core fiber.

The anti-resonance units can be connected to the sheath tube inner face in particular during a second hot-forming process.

During the preparation step, the jacket tube is prepared. The jacket tube is an elongated hollow body whose length is significantly greater than its diameter. The jacket tube comprises a jacket tube inner bore and a jacket tube longitudinal axis along which a jacket tube wall extends, the jacket tube wall being delimited by a jacket inner face and a jacket outer face. Due to the tubular structure, the jacket tube has a hollow core that extends along the jacket tube's longitudinal axis. In particular, the jacket tube can have a length of at least 1 m, in particular b m. In one embodiment, the jacket tube comprises or consists of a material which is transparent to a working light of the optical fiber, for example, glass, in particular doped or non-doped quartz glass (SiO₂). Doping allows the adjustment of physical properties, such as the thermal expansion coefficient. Dopants used to lower the viscosity of quartz glass are preferably fluorine, chlorine, and/or hydroxyl groups. In one embodiment, the anti-resonance units, the jacket tube and the sheath tube are the same material.

During the introducing step, the hollow-core assembly is at least partially inserted into the inner bore of the jacket tube. The aim is for the hollow-core assembly to be arranged in the inner bore of the jacket tube. One embodiment is wherein the hollow-core assembly has three, four, five, six, seven or eight anti-resonance units.

During the drawing step, the transverse extension of the jacket tube and the hollow-core assembly is reduced in order to obtain the hollow-core fiber. During the drawing step, the longitudinal extent of the fiber assembly consisting of the jacket tube and the hollow-core assembly can be increased and/or the transverse extent can be reduced. Drawing can be true to scale so that, for example, the geometric shape and arrangement of components or constituents are reflected in the drawn end product.

The drawing step takes place during a hot forming process. The term “hot forming process” refers to a method step in which the temperature of an element is increased by applying heat. Examples of hot forming processes are:

Flame-based hot forming processes are based on the oxidation of an exothermically reacting gas. One example is the use of hydrogen, also referred to as “H2”, as fuel gas (flame hydrolysis). The hydrogen reacts with oxygen-also known as “O2”—which either comes from the air or is added separately.

Flame-free hot forming processes use other heating systems that do not require an open flame. One example is the use of a resistor that converts electrical energy into thermal energy (heat).

During the drawing, the fiber assembly, comprising the jacket tube and the hollow-core assembly, can be further processed by at least one of the hot forming processes of elongation and collapse.

In the context of the invention, the term elongation means an increase in the longitudinal extent of a body. This increase in longitudinal extent can be accompanied by a reduction in the transverse extent of the fiber assembly. Elongation can be true to scale so that, for example, the shape and arrangement of components or constituents are reflected in the elongated end product.

In the context of the invention, the term collapse means a reduction in the transverse extent of a body. This reduction in the transverse extent of the fiber assembly can occur during an increase in the temperature of the body and can lead to an increase in the longitudinal extent of the body.

The drawing step comprises a hot forming process to draw the fiber assembly, comprising the jacket tube and hollow-core assembly, into a hollow-core fiber with an outer diameter of less than 500 mm. In order to increase the longitudinal extent and/or reduce the transverse extent of the fiber assembly, the fiber assembly can be partially heated in a drawing tower to a temperature in the range of 1,800 to 2,200 degrees Celsius. The drawing tower can have an oven in which one end of the fiber assembly is heated until a piece of molten material falls out of the fiber assembly and forms a thin strand which is the beginning of the hollow-core fiber.

To influence the shape and arrangement of the anti-resonance units in the hollow-core fiber, inflation of cavities can be used in the drawing step. The final size of the anti-resonance units in the hollow-core fiber is difficult to control due to the small wall thickness. If the anti-resonance units in the hollow-core fiber are too small and therefore the distances between the anti-resonance units are too large, the hollow-core fiber can have high attenuation. If the geometric size of the anti-resonance units in the hollow-core fiber is too large, if they are inflated too much, contact between neighboring anti-resonance units in the hollow-core fiber can occur, which also leads to increased attenuation. In particular, the final size of the anti-resonance units in the hollow-core fiber can be better controlled if the capillaries have a low temperature and accordingly an increased viscosity.

It was surprisingly found that the ratio of the geometric size of the jacket tube and the hollow-core assembly during the drawing step has a positive effect on the temperature of the anti-resonance units. To fulfill the tasks listed above, it is intended that in the step of drawing the hollow core fiber:
the sheath tube has a sheath tube diameter of at least 8 mm,
the jacket tube has a jacket tube diameter of at least 25 mm, and,
a ratio of a jacket tube cross-sectional area of the jacket tube wall to a sheath tube cross-sectional area of the sheath tube wall lies within the interval [5; 40].

In the context of the invention, a cross-sectional area refers to the area that runs perpendicular to a specific direction or axis and represents the cross-section of an object. The sheath tube cross-sectional area is defined as the area that results from the intersection of a plane running perpendicular to the sheath tube longitudinal axis with the sheath tube. Due to production-related fluctuations in the sheath tube diameter and/or the wall thickness of the sheath tube wall, the magnitude of the sheath tube cross-sectional area over the entire length of the sheath tube can be subject to a fluctuation of 10%, in particular 5%. The jacket tube cross-sectional area is defined as the area resulting from the intersection of a plane running perpendicular to the jacket tube longitudinal axis with the jacket tube. Due to production-related fluctuations in the jacket tube diameter of the jacket tube and/or the wall thickness of the jacket tube wall, the magnitude of the jacket tube cross-sectional area over the entire length of the jacket tube can be subject to a fluctuation of 10%, in particular 5%.

It is provided that the ratio of the jacket tube cross-sectional area to the sheath tube cross-sectional area must be available during the drawing step. The ratio does not have to exist at just any point over the course of the process, but rather during the drawing step, i.e., immediately before the greatest heat exposure. This can be the case when the fiber assembly, comprising the jacket tube and hollow-core assembly, is introduced into the oven in the drawing tower.

Furthermore, it is provided that the sheath tube has a sheath tube diameter of at least 8 mm and the jacket tube has a jacket tube diameter of at least 25 mm. Therefore, both the sheath tube as well as the jacket tube require a minimum wall thickness to achieve the described effect.

Furthermore, it is provided that the ratio of a jacket tube cross-sectional area of the jacket tube wall to a sheath tube cross-sectional area of the sheath tube wall lies within the interval [5; 40].

Surprisingly, it has been shown that with a ratio of the jacket tube cross-sectional area to the sheath tube cross-sectional area in the interval [5; 40], two opposing effects occurring in the drawing step of an anti-resonant hollow-core fiber with an outer diameter of less than 500 mm are optimally adjusted if:
on the one hand, a reduction in the temperature on the jacket inner face—i.e., also on the anti-resonance units—takes place, and
on the other hand, the wall thickness of the jacket tube wall is large enough to absorb the majority of the stress occurring during drawing.

It seems as if the said ratio has an influence on the temperature on the sheath tube inner face—i.e., also, on the anti-resonance units.

On the one hand, the temperature of the jacket material should be high to ensure a suitable viscosity for the drawing step. On the other hand, the temperature on the sheath tube inner face—and therefore also on the anti-resonance units—should be so low that drawing preferably does not negatively affect the shape of the anti-resonance units.

A thin-walled jacket tube in combination with a very thick-walled sheath tube would more strongly reduce the temperature on the sheath tube inner face. However, the drawing step is associated with shearing in the material, in particular in quartz glass, which leads to the introduction of stresses. If the hollow-core assembly had a sheath tube dimension that was too large—i.e., very thick-walled—the differences in flow velocities-from the outside of the sheath tube in relation to the area of the anti-resonance units-would be too large, so that too much stress would be frozen within the hollow-core fiber. This could negatively affect the strength of the hollow-core fiber.

A thick-walled jacket tube in combination with a very thin-walled sheath tube could result in the jacket tube dominating the drawing temperature in the drawing step and having to be heated very strongly. Although the jacket tube would absorb the majority of the stresses, the anti-resonance units would be exposed to higher temperatures and potentially collapse more severely, which would run counter to the desired structural integrity.

A further embodiment is wherein the ratio of the jacket tube cross-sectional area to the sheath tube cross-sectional area has at least one of the following features:
it is less than or equal to 37, less than or equal to 35, or less than or equal to 30;
it is greater than or equal to 9, greater than or equal to 12, or greater than or equal to 15, in particular greater than or equal to 20.

These further restrictions on the ratio of the jacket tube cross-sectional area to the sheath tube cross-sectional area surprisingly lead to a reduction in the deformation of the anti-resonance units during the manufacture of the hollow-core fiber.

Another embodiment is wherein the anti-resonant hollow-core fiber has an outer diameter of less than 450 mm, in particular less than 400 mm, in particular less than 300 mm, in particular less than 270 mm, in particular less than 250 mm. To produce an anti-resonant hollow-core fiber with a smaller outer diameter, the fiber assembly needs to be heated more and more. The use of the ratio of the cross-sectional area according to the invention ensures that the deformation of the anti-resonance units due to the heat input during the production of the hollow-core fiber is minimized.

A further embodiment is wherein the core radius R_Faser comprises at least one of the following features:
it is less than or equal to 26 mm, less than or equal to 23 mm, or less than or equal to 20 mm; and
it is greater than or equal to 10 mm, greater than or equal to 12 mm, or greater than or equal to 14 mm.

The hollow-core fiber has a core radius which results from the shortest distance between a longitudinal axis of the anti-resonant hollow-core fiber and the anti-resonance unit. To produce an anti-resonant hollow-core fiber with a smaller core radius, the fiber assembly needs to be heated more and more. The use of the ratio of the cross-sectional area according to the invention ensures that the deformation of the anti-resonance units due to the heat input during the production of the hollow-core fiber is minimized.

A further embodiment is wherein the sheath tube comprises at least one of the following features:
the sheath tube diameter is less than or equal to 100 mm, less than or equal to 90 mm, less than or equal to 75 mm, less than or equal to 50 mm;
the sheath tube diameter is greater than or equal to 10 mm, greater than or equal to 15 mm, greater than or equal to 20 mm;
the sheath tube wall has a wall thickness of more than 2 mm, more than 3 mm, more than 5 mm, more than 7.5 mm;
the sheath tube wall has a wall thickness of less than 25 mm, less than 20 mm, less than 15 mm;
the sheath tube has a sheath tube length of at least 1 m;
a magnitude of the wall thickness of the sheath tube wall varies over the sheath tube length by less than 10%, in particular 5%, in particular 3% of the wall thickness.

The listed parameters positively influence the effect of temperature reduction of the anti-resonance unit.

A further embodiment is wherein the sheath tube comprises at least one of the following features:
the jacket tube diameter is less than or equal to 290 mm, in particular less than or equal to 220 mm, in particular less than or equal to 180 mm, in particular less than or equal to 150 mm;
the jacket tube diameter is greater than or equal to 50 mm, in particular greater than or equal to 60 mm, in particular greater than or equal to 75 mm, in particular greater than or equal to 85 mm;
the jacket tube wall has a wall thickness of more than 15 mm, in particular more than 20 mm, in particular more than 30 mm, in particular more than 40 mm;
the jacket tube wall has a wall thickness of less than 90 mm, in particular less than 80 mm, in particular less than 70 mm, in particular less than 60 mm;
the jacket tube has a jacket tube length of at least 1 m;
a magnitude of the wall thickness of the jacket tube wall varies over the jacket tube length by not more than 10%, in particular 5%, in particular 3% of the wall thickness.

The listed parameters positively influence the effect of temperature reduction of the anti-resonance unit.

A further embodiment is wherein the sheath tube length and the jacket tube length, in particular the sheath tube length, the jacket tube length and a length of the anti-resonance units, differ by not more than 15%, in particular 10%, in particular 5%, relative to the jacket tube length. In this embodiment, the sheath tube length and the jacket tube length match within the specified differences. This in particular facilitates the connection in the step of creating the hollow-core assembly.

A further embodiment is wherein the method comprises at least one of the following features:
a magnitude of the sheath tube cross-sectional area of the sheath tube wall varies over the sheath tube length by not more than 10%, in particular 5%, in particular 3%;
a magnitude of the jacket tube cross-sectional area of the jacket tube wall varies over the jacket tube length by not more than 10%, in particular 5%, in particular 3%; and,
a magnitude of the ratio of the jacket tube cross-sectional area to the sheath tube cross-sectional area varies over the jacket tube length by not more than 10%, in particular 5%, in particular 3%, relative to the jacket tube cross-sectional area.

Due to production reasons, there are variations in the geometric dimensions of the jacket tube and/or the sheath tube. These can lie within a given interval to further describe the ratio according to the invention.

A further embodiment is wherein the method between the introducing step and the drawing step is free of hot forming process steps. “Free of hot forming process steps” means that between the two steps of introducing and drawing, no heating takes place that significantly changes the viscosity of the two elements, the hollow-core assembly and the jacket tube, in particular to temperatures above 500° C. This has the advantage that there is no heating of the anti-resonance elements, which could lead to a deformation of the geometric design, which can result in increased attenuation of the hollow-core fiber.

A further embodiment is wherein the method is free of intermediate steps between the introducing step and the drawing step. In this case, “free of intermediate steps” means that between the two steps of introducing and drawing there is no further intermediate step that leads to a structurally significant and/or chemically significant change in the two elements, the hollow-core assembly and the jacket tube. “Free of intermediate steps” does not include method steps such as cleaning, polishing, and/or checking the hollow-core assembly and/or the jacket tube. The embodiment that is free of intermediate steps has the advantage that the ratio of the jacket tube cross-sectional area to the sheath tube cross-sectional area is maintained between the two steps of introducing and drawing. This facilitates the correct adjustment of the ratio to thereby ensure the reduced temperature at the anti-resonance units.

A further embodiment is wherein heat introduced into the jacket tube in the hot-forming process in the step of drawing is subject to at least two heat transfers during transfer between the jacket tube and the sheath tube, in particular that, after the step of introducing, there is a gap between the jacket tube and the hollow-core assembly, so that heat introduced into the jacket tube in particular in the hot-forming process in the step of drawing is subject to at least two heat transfers in the gap.

As described above, the introducing step involves at least partial insertion of the hollow-core assembly into the inner bore of the jacket tube. To ensure this mechanical insertion, the maximum diameter of the hollow-core assembly must be smaller than the minimum diameter of the jacket tube inner bore. Consequently, a gap forms between the jacket tube and the hollow-core assembly. Surprisingly, it was found that the design of this gap has a significant influence on the maximum temperature of the anti-resonance units in the drawing step.

The term heat transport (also heat transfer) is understood to be the transport of energy in the form of heat across at least one thermodynamic system boundary. There are three types of heat transport mechanisms:
in thermal conduction or conduction, kinetic energy is transferred between neighboring atoms or molecules without the transport of material;
in heat flow or convection, thermal energy is carried along in a flowing medium; in thermal radiation, thermal energy is transmitted as electromagnetic waves.

A change in the type of heat transport mechanism is often referred to as heat transfer, which is described by a heat transfer coefficient. The physical quantity of heat transfer is the heat flow. This describes the amount of heat energy that is transferred from a place of high temperature to a place of low temperature over a span of time.

A further embodiment is wherein a first heat transfer coefficient at an outer interface between the gap and the jacket inner face lies within the interval [65; 180] W/(m²*K), in particular within the interval [90; 150] W/(m²*K) for 500-900° C. These structural properties of the hollow-core fiber, in conjunction with the ratio of the jacket tube cross-sectional area to the sheath tube cross-sectional area, lead to a further reduction in the temperature on the inner surface of the sheath tube.

A further embodiment is characterized by a second heat transfer coefficient at an inner interface between the gap and the sheath tube outer face within the interval [65; 180] W/(m²*K), in particular within the interval [90; 150] W/(m²*K) for 500-900° C. These structural properties of the hollow-core fiber, in conjunction with the ratio of the jacket tube cross-sectional area to the sheath tube cross-sectional area, also lead to a further reduction in the temperature on the inner surface of the sheath tube.

A further embodiment is wherein, when the hollow-core assembly is centered in the jacket tube inner bore, the gap has at least one of the following features:
the radial size of the gap is less than or equal to 4 mm, in particular less than or equal to 3 mm, in particular less than or equal to 2 mm, in particular less than or equal to 1 mm;
the radial size of the gap is greater than or equal to 0.05 mm, in particular greater than or equal to 0.1 mm, 0.3 mm, in particular greater than or equal to 0.5 mm, in particular greater than or equal to 0.75 mm, in particular greater than or equal to 0.85 mm.

The geometric size of the gap can influence the temperature of the anti-resonance units in the drawing step. Surprisingly, it was found that the gap is particularly effective in damping the transport of heat from the jacket into the anti-resonance units, in particular within one of the above-mentioned parameters.

A further embodiment is wherein the method comprises at least one of the following steps:
coating the hollow-core fiber with at least one layer, in particular a layer comprising light-curing polymer; and,
winding the hollow-core fiber onto a spool.

The hollow-core fiber drawn from the oven is thermally deformed, but microcracks appear on the surface of the bare hollow-core fiber. Once these microcracks are exposed to the atmosphere, they can enlarge due to the H2O in the atmosphere. In order to increase the strength of the hollow-core fiber, a thin layer, in particular a polymer layer, is applied to the hollow-core fiber after the drawing step.

A further embodiment is wherein the hollow-core fiber comprises at least one of the following features:
sheath tube, and/or anti-resonance units, and/or ARU outer tube, and/or ARU inner tube, and/or jacket tube comprises an amorphous solid, in particular a glass, in particular quartz glass;
sheath tube and/or anti-resonance units, and/or ARU outer tube, and/or ARU inner tube, and/or jacket tube consists of an amorphous solid, in particular a glass, in particular quartz glass; and,
at least two of the sheath tube, anti-resonance units, ARU outer tube, ARU inner tube and jacket tube are the same material, in particular comprise or consist of a glass having a refractive index of at least 1.4, 1.4 to 3, or 1.4 to 2.8.

The above-mentioned features lead to a further temperature reduction, in particular in the region of the anti-resonance units in the drawing step. These structural properties of the hollow-core fiber, in conjunction with the ratio of the jacket tube cross-sectional area to the sheath tube cross-sectional area, lead to a further reduction in the temperature on the inner surface of the sheath tube.

The term interval [a; b] describes a connected subset of the set of real numbers R:

$$[ a ; b ] := \{ x ∈ ℝ \vert a \leq x \leq b \}$$

The term “within the interval [a; b]” is to be understood as including both endpoints of the range—i.e., a and b.

Furthermore, disclosures of ranges are preferably to be understood that they comprise both end points of the range. Furthermore, any disclosure of a range in this document should preferably be understood such that they also disclose preferred subranges in which one endpoint is excluded or both endpoints are excluded. For example, specifying a range from X1 to X2 is to be understood such that a range is specified that includes the two endpoints X1 and X2. The properties and features disclosed in the description may be essential for various embodiments of the claimed invention, both separately and in any combination with one another.

### BRIEF DESCRIPTION OF THE DRAWINGS

The invention is further illustrated by way of example below by means of figures. The invention is not limited to the figures shown:

FIG. 1 is a cross-section through an anti-resonance unit and an enlarged detail of a seam line;

FIG. 2 is a cross-section through a sheath tube and three anti-resonance units;

FIG. 3 is a cross-section through a jacket tube;

FIG. 4 is a hollow-core assembly and the jacket tube;

FIG. 5 a cross-section through the hollow-core assembly and the jacket tube from FIG. 4;

FIG. 6 is a cross-section through the hollow-core assembly and the jacket tube, an oven and an anti-resonant hollow-core fiber;

FIG. 7 is a cross-section through the anti-resonant hollow-core fiber;

FIG. 8 shows method steps for the production of an anti-resonant hollow-core fiber;

FIG. 9 is a further cross-section through a sheath tube and a jacket tube;

FIG. 10 is a further cross-section through a sheath tube and a jacket tube;

FIG. 11 is a further cross-section through an oven, a sheath tube and a jacket tube; and,

FIG. 12 is a diagram of a temperature along the sheath tube inner face, plotted against a distance to an oven underside.

### DETAILED DESCRIPTION OF THE INVENTION

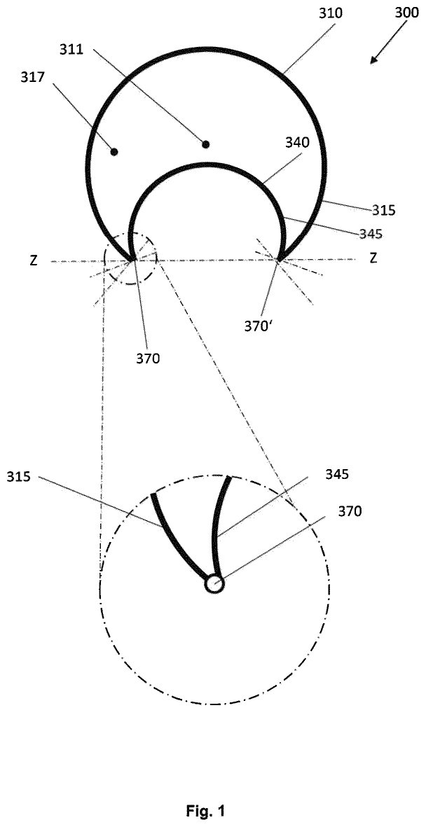

A starting point for the method for producing an anti-resonant hollow-core fiber with an outer diameter of less than 500 mm is a preparation 3100 of a number of anti-resonance units 300. FIG. 1 shows an anti-resonance unit 300. In the shown variant, the anti-resonance unit 300 comprises an ARU outer tube 310 and an ARU inner tube 340 inserted therein. The ARU outer tube 310 is a tubular structure which, in the illustrated embodiment, has an arcuate cross-section. The ARU outer tube 310 is a tube-like structure. In FIG. 1, the ARU outer tube 310 and the ARU inner tube 340 inserted therein extend into the plane of the drawing.

The ARU outer tube 310 has an ARU outer wall 315 which comprises or consists of a material which is transparent to a working light of the optical fiber, for example, glass, in particular doped or undoped quartz glass (SiO₂).

The cross-section shown in FIG. 1 illustrates that the ARU outer tube 310 has an arcuate cross-section. In the context of the invention, the term circular arc refers to a portion of a circular line. Two points on a circle divide the circle line into two circular arcs. The term circular arc describes when an external shape of an element follows the course of one of said two circular arcs.

Furthermore, FIG. 1 shows a cross-section through the ARU inner tube 340. The ARU inner tube 340 is a tube-like structure that has an arcuate cross-section. The ARU inner tube 340 has a wall 345 which comprises or consists of a material which is transparent to a working light of the optical fiber, for example, glass, in particular doped or undoped quartz glass (SiO₂).

The arcuate-shaped ARU outer tube 310 and the arcuate-shaped ARU inner tube 340 are connected to each other along two connecting lines 370, 370′ arranged substantially parallel to a longitudinal axis 311. In particular, this bond can have been achieved by a hot forming process. For clarity, a part of the anti-resonance unit 300 is shown enlarged around the connecting line 370 in FIG. 1.

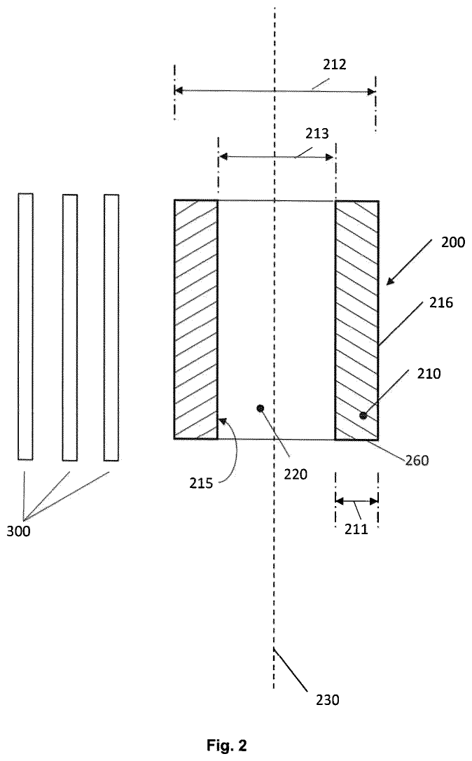

A further step of the method for producing an anti-resonant hollow-core fiber comprises providing 3000 a sheath tube 200. FIG. 2 shows a cross-section through a sheath tube 200, which comprises a sheath tube inner bore 220 and a sheath tube longitudinal axis 230 along which a sheath tube wall 210 extends, the sheath tube wall being delimited by a sheath tube inner face 215 and a sheath tube outer face 216. The sheath tube 200 has a sheath tube diameter 212 and a sheath tube inner diameter 213. The sheath tube wall 210 has a wall thickness 211. The sheath tube 200 can have at least one of the following features:
the sheath tube diameter 212 is less than or equal to 100 mm, less than or equal to 90 mm, less than or equal to 75 mm, less than or equal to 50 mm;
the sheath tube diameter 212 is greater than or equal to 10 mm, greater than or equal to 15 mm, greater than or equal to 20 mm;
the sheath tube wall 210 has a wall thickness 211 of more than 2 mm, more than 3 mm, more than 5 mm, more than 7.5 mm;
the sheath tube wall 210 has a wall thickness 211 of less than 25 mm, less than 20 mm, less than 15 mm;
the sheath tube 200 has a sheath tube length of at least 1 m; and,
a magnitude of the wall thickness 211 of the sheath tube wall 210 varies over the sheath tube length by less than 10%, in particular 5%, in particular 3% of the wall thickness.

During an insertion step 3200, at least parts of the anti-resonance units 300 are introduced into the sheath tube inner bore 220. Furthermore, the anti-resonance units 300 can be arranged at desired positions in the sheath tube inner bore 220.

In the creating step 3300, a hollow-core assembly 400 is created from the sheath tube 200 and the anti-resonance units 300. For this purpose, the anti-resonance units 300 are connected at least partially to the sheath tube inner face 215. The connecting can be done during a hot forming process.

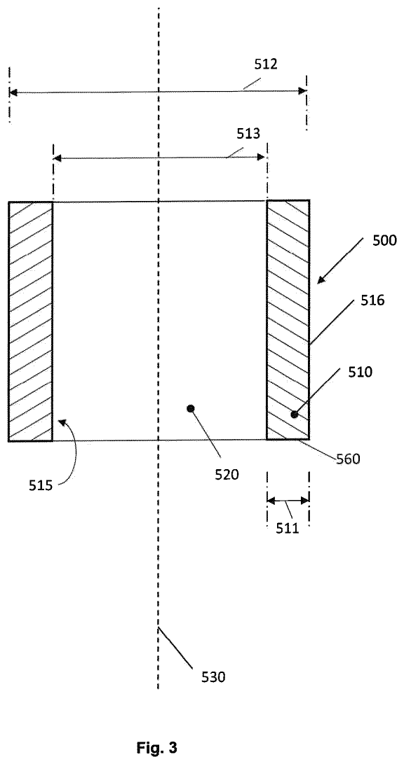

A further step of the method for producing an anti-resonant hollow-core fiber comprises preparing 3100 a jacket tube 500. FIG. 3 shows a cross-section through a jacket tube 500. The jacket tube 500 comprises a jacket tube inner bore 520 and a jacket tube longitudinal axis 530 along which a jacket tube wall 510 extends, the jacket tube wall being delimited by a jacket inner face 515 and a jacket outer face 516. The jacket tube 500 has a jacket tube diameter 512 and a jacket tube inner diameter 513. The jacket tube wall 510 has a wall thickness 511. The jacket tube 500 can have at least one of the following features:
the jacket tube diameter 512 is less than or equal to 290 mm, in particular less than or equal to 220 mm, in particular less than or equal to 180 mm, in particular less than or equal to 150 mm;
the jacket tube diameter 512 is greater than or equal to 50 mm, in particular greater than or equal to 60 mm, in particular greater than or equal to 75 mm, in particular greater than or equal to 85 mm;
the jacket tube wall 510 has a wall thickness 511 of more than 20 mm, in particular more than 30 mm, in particular more than 40 mm, in particular more than 50 mm;
the jacket tube wall 510 has a wall thickness 511 of less than 90 mm, in particular less than 80 mm, in particular less than 70 mm, in particular less than 60 mm;
the jacket tube has a jacket tube length of at least 1 m; and,
a magnitude of the wall thickness 511 of the jacket tube wall 510 varies over the jacket tube length by not more than 10%, in particular 5%, in particular 3% of the wall thickness 511.

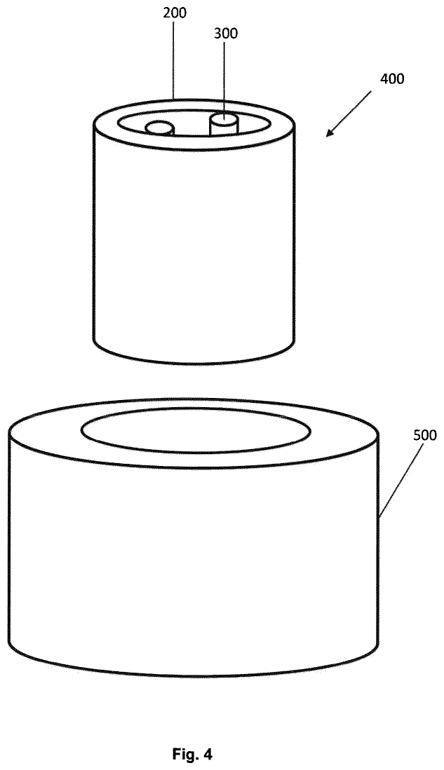

FIG. 4 shows a three-dimensional representation of the hollow-core assembly 400 as well as the jacket tube 500. In this embodiment, the hollow-core assembly 400 has two anti-resonance units 300 which are connected to the sheath tube inner face 215 of the sheath tube 200. Depending on the intended use of the anti-resonant hollow-core fiber 1000, the hollow-core assembly 400 can have three, four, five, six, seven or eight anti-resonant units 300. The at least partial connection of the anti-resonance units 300 to the sheath tube inner face 215 can comprise at least one of the following features:
connecting in a second hot-forming process, in particular selected from at least one of elongating and collapsing;
integrally connecting the anti-resonance units 300 to the sheath tube inner face 215 along a connection seam; and,
integrally connecting, at points, the anti-resonance units 300 to parts of the sheath tube inner face 215 of the sheath tube wall 210.

Depending on the embodiment, the sheath tube length and the jacket tube length, in particular the sheath tube length, the jacket tube length and a length of the anti-resonance units, can differ by no more than 15%, in particular 10%, in particular 5%, based on the jacket tube length.

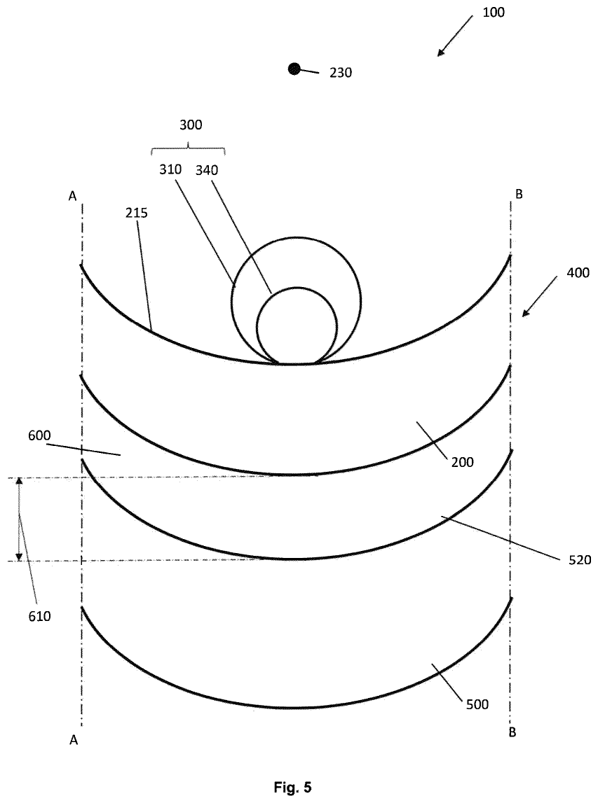

FIG. 5 shows a cross-section through a fiber assembly 100, comprising a jacket tube 500 and a hollow-core assembly 400 between two intersection lines AA and BB. The illustrated section of the hollow-core assembly 400 comprises the sheath tube 200 and the anti-resonance unit 300, which are connected to the sheath tube inner face 215 of the sheath tube 200. The anti-resonance unit 300 comprises the ARU outer tube 310 and the ARU inner tube 340. The hollow-core assembly 400 is surrounded by the jacket tube 500.

To ensure introducing 3500 of the hollow-core assembly 400 into the jacket tube 500, the maximum diameter of the hollow-core assembly must be smaller than the minimum diameter of the jacket tube inner bore. Consequently, a gap 600 forms between the jacket tube 500 and the hollow-core assembly 400. This gap 600 has a radial size 610. Surprisingly, it was found that the design of this gap has a significant influence on the maximum temperature of the anti-resonance units in the drawing step.

In one embodiment, the gap 600, which exists between the jacket tube 500 and the hollow-core assembly, is such that heat introduced into the jacket tube 500, in particular during the hot forming process in the drawing step, is subject to at least two heat transitions in the gap 600. In particular, given a centered position of the hollow-core assembly 400 in the jacket tube inner bore 520, the gap 600 can have at least one of the following features:
the radial size 610 of the gap 600 is less than or equal to 4 mm, in particular less than or equal to 3 mm, in particular less than or equal to 2 mm, in particular less than or equal to 1 mm; and,
the radial size 610 of the gap 600 is greater than or equal to 0.3 mm, in particular greater than or equal to 0.5 mm, in particular greater than or equal to 0.75 mm, in particular greater than or equal to 0.85 mm.

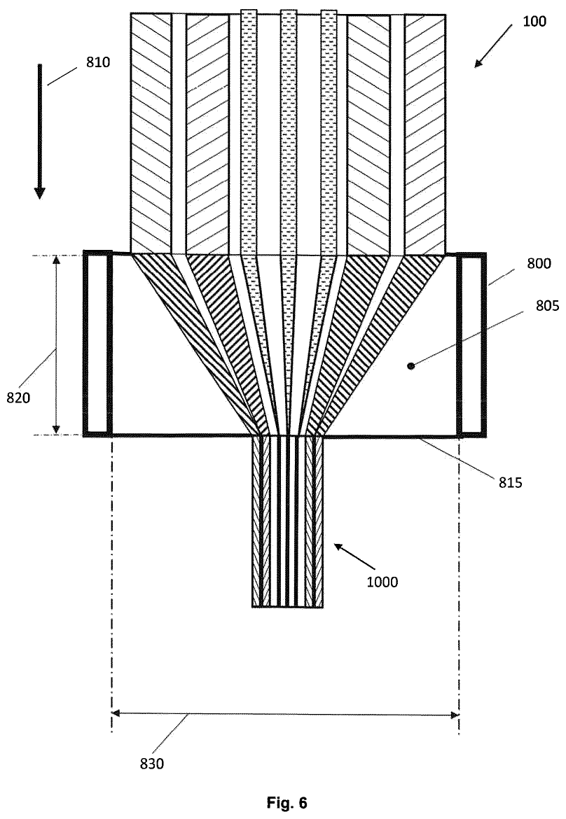

During a drawing step 3600, the longitudinal extent is increased and/or the transverse extent of the fiber assembly consisting of the jacket tube and the hollow-core assembly is reduced. This is done during a hot forming process. The term “hot forming process” refers to a method step in which the temperature of an element is increased by applying heat. The drawing step 3600 is in particular illustrated by FIG. 6 which shows the passage of the fiber assembly 100 through an electric oven 800. The oven 800 is a device for the controlled generation of heat for the transfer of this heat into a spatial zone 805. A movement arrow 810 illustrates the direction from which the fiber assembly 100 is moved into spatial zone 805 at a defined feed rate. The oven 800 has an oven height 820 and an inner diameter 830.

The effect of the heat on the fiber assembly 100 softens its material so that an active and/or passive effect results in an increase in the longitudinal extent and/or a reduction in the transverse extent. At the end of the oven run, the anti-resonant hollow-core fiber 1000 is created.

The following exemplary figures illustrate the effects that the drawing step 3600 can have on the geometric size of the fiber assembly 100. Accordingly, the jacket tube 500 can have a jacket tube diameter of less than or equal to 290 mm, in particular less than or equal to 220 mm. After passing through the oven 800, the anti-resonant hollow-core fiber can have an outer diameter of less than 500 mm, in particular less than 300 mm. The reduction of the transverse extent that can occur in the drawing step 3600 is accordingly almost three orders of magnitude.

Furthermore, the drawing 3600 can be true to scale so that, for example, the shape and arrangement of components or constituents of the primary preform are reflected in the elongated end product. In particular, the drawing 3600 can be carried true to scale in such a way that the ratios of the geometric shapes of the anti-resonance units 300, in particular the ARU outer tube 310 and ARU inner tube 340, can be maintained before and after drawing. In this case, the geometric shape, extent and arrangement of the components or constituents of the fiber assembly 100 are reflected in the drawn final product.

Furthermore, the drawing 3600 can be carried out in such a way that different regions in the fiber assembly are subject to different geometric changes. For example, by applying an overpressure in the ARU outer tube 310 and/or ARU inner tube 340, the given geometry changes in the drawing step 3600 can be varied. Furthermore, by applying different pressures in the given components of the fiber assembly 100 during drawing 3600, the following ratios can be changed:
jacket tube diameter 512 to jacket tube inner diameter 513,
sheath tube diameter 212 to sheath tube inner diameter 213,
outer diameter to inner diameter of the ARU outer tube 310, and/or
outer diameter to inner diameter of the ARU inner tube 340. Furthermore, the size ratios of the jacket tube 500, sheath tube 200, ARU outer tube 310 and/or ARU inner tube 340 to each other can be changed by different pressures.

A further embodiment is wherein the method between the introducing step 3500 and the drawing step 3600 is free of hot forming process steps. “Free of hot forming process steps” means that between the two steps of introducing 3500 and drawing 3600, no heating takes place that significantly changes the viscosity of the two elements, the hollow-core assembly and the jacket tube, in particular to temperatures above 500° C.

In particular, the drawing step 3600 can be followed by at least one of the following steps:
coating the hollow-core fiber with at least one layer, in particular a layer comprising light-curing polymer;
winding the hollow-core fiber onto a spool.

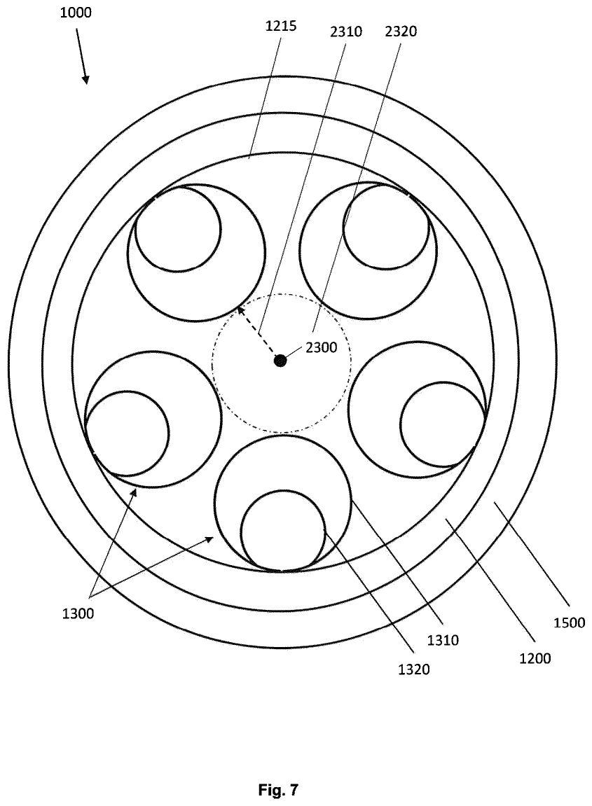

FIG. 7 also illustrates the result of the drawing step 3600, which shows a cross-section through an anti-resonant hollow-core fiber 1000 that was made from a fiber assembly 100. The anti-resonant hollow-core fiber 1000 has a hollow core 2320. An electromagnetic wave can propagate through the hollow core 2320. The hollow-core fiber 1000 has a core radius 2310 which results from the shortest distance between a longitudinal axis 2300 of the anti-resonant hollow-core fiber 1000 and a fiber ARU outer tube 1310. FIG. 7 illustrates that in the drawing step 3600, a transition occurs in which:
a sheath tube 200 becomes a fiber sheath tube 1200,
a jacket tube 500 becomes a fiber jacket tube 1500,
an anti-resonance unit 300 becomes a fiber anti-resonance unit 1300,
an ARU outer tube 310 becomes a fiber ARU outer tube 1310, and
an ARU inner tube 340 becomes a fiber ARU inner tube 1320.

The fiber sheath tube 1200 and the fiber jacket tube 1500 are integrally connected in such a way that a distinction between the two is not possible or only possible with great effort. FIG. 7 further illustrates the arrangement of the plurality of fiber anti-resonance units 1300 on the inner surface 1215 delimiting the hollow core. In one embodiment, the anti-resonant hollow-core fiber 1000 can have three, four, five, six, seven or eight fiber anti-resonance units 1300.

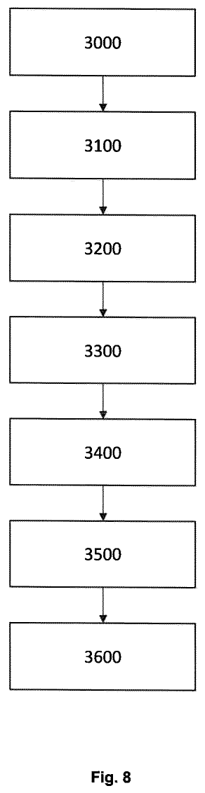

As FIG. 8 shows, the method for producing an anti-resonant hollow-core fiber 1000 with an outer diameter of less than 500 mm comprises the steps:
providing 3000 a sheath tube 200, which comprises a sheath tube inner bore 220 and a sheath tube longitudinal axis 230 along which a sheath tube wall 210 extends, the sheath tube wall being delimited by a sheath tube inner face 215 and a sheath tube outer face 216,
preparing 3100 a number of anti-resonance units 300, each comprising an ARU outer tube 310,
inserting 3200 at least parts of the anti-resonance units 300 into the sheath tube inner bore 220,
creating 3300 a hollow-core assembly 400 comprising the sheath tube 200 and the anti-resonance units 300 by at least partially connecting the anti-resonance units 300 to the sheath tube inner face 215,
preparing 3400 a jacket tube 500, which comprises a jacket tube inner bore 520 and a jacket tube longitudinal axis 530 along which a jacket tube wall 510 extends, the jacket tube wall being delimited by a jacket inner face 515 and a jacket outer face 516,
introducing 3500 at least parts of the hollow-core assembly 400 into the jacket tube inner bore 520,
drawing 3600 the hollow-core fiber 1000 from the jacket tube 500 and the hollow-core assembly 400 by means of a hot-forming process.

It is provided that in the drawing step 3600 of the hollow-core fiber 1000,
the sheath tube 200 has a sheath tube diameter 212 of at least 8 mm,
the jacket tube 500 has a jacket tube diameter 512 of at least 25 mm, and
a ratio of a jacket tube cross-sectional area 550 of the jacket tube wall 510 to a sheath tube cross-sectional area 450 of the sheath tube wall 410 lies within the interval [5; 40].

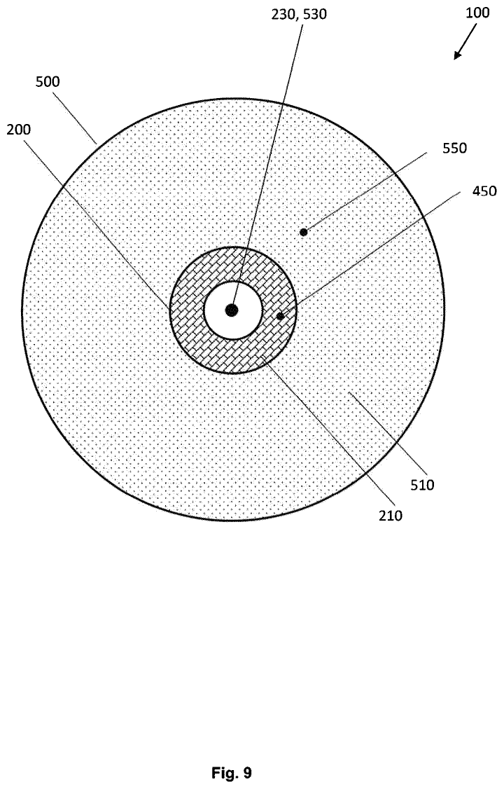

FIG. 9 shows a cross-section through a fiber assembly 100 having a jacket tube 500 and a hollow-core assembly 400. The sheath tube 200 has a sheath tube wall 210 which has the sheath tube cross-sectional area 450. The jacket tube 500 has a jacket tube wall 510 which has the jacket tube cross-sectional area 550.

The sheath tube cross-sectional area 450 refers to the area that results from the intersection of a plane running perpendicular to the sheath tube longitudinal axis 230 with the sheath tube 200. The jacket tube cross-sectional area 550 is defined as the area that results from the intersection of a plane running perpendicular to the sheath tube longitudinal axis 530 with the jacket tube 500. In FIG. 9, the sheath tube 200 and the jacket tube 500 are aligned with each other such that the jacket tube longitudinal axis 530 and the sheath tube longitudinal axis 230 are congruent.

The method is wherein the ratio of the jacket tube cross-sectional area 550 to a sheath tube cross-sectional area 450 lies in the interval [5; 40]. Surprisingly, it has been shown that, only in the disclosed interval,
on the one hand, a reduction in the temperature on the jacket inner face 515 as well as on the anti-resonance units 300 takes place, and
on the other hand, the wall thickness 511 of the jacket tube wall 510 is large enough to absorb the majority, in particular more than 80%, of the stress occurring during drawing 3600.

A further embodiment of the method is wherein the ratio of the jacket tube cross-sectional area 550 to the sheath tube cross-sectional area 450 has at least one of the following features:
it is less than or equal to 3, in particular less than or equal to 35, in particular less than or equal to 30;
it is greater than or equal to 9, in particular greater than or equal to 12, in particular greater than or equal to 15, in particular greater than or equal to 20.

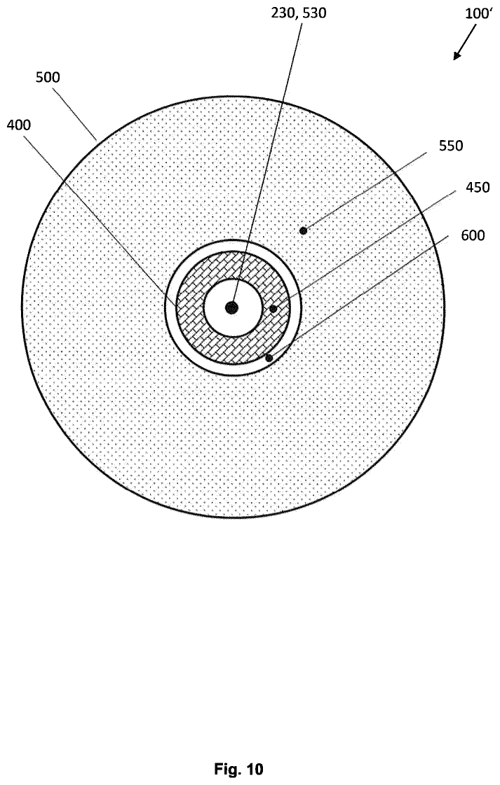

FIG. 10 shows a cross-section through an embodiment of a fiber assembly 100′, comprising a jacket tube 500 and a hollow-core assembly 400. The fiber assembly 100′ differs from the fiber assembly 100 only in that after the introducing step 3500, there is a gap 600 between the jacket tube 500 and the sheath tube 200. All other elements of the fiber assembly 100′ match the fiber assembly 100.

In particular, the gap 600 can be designed such that heat introduced into the jacket tube 500 in the drawing step during the hot forming process is subject to at least two heat transitions in the gap 600.

A first heat transfer coefficient at an outer interface between the gap and the jacket inner face can lie within the interval [65; 180] W/(m²*K), in particular within the interval [90; 150] W/(m²*K) for 500-900° C. Alternatively, or additionally, a second heat transfer coefficient at an inner interface between the gap and the sheath tube outer surface can lie within the interval [65; 180] W/(m²*K), in particular within the interval [90; 150] W/(m²*K) for 500-900° C.

Accordingly, given a centered position of the hollow-core assembly 400 in the jacket tube inner bore 520, the size 610 of the gap 600 can have at least one of the following features:
the gap is less than or equal to 4 mm, less than or equal to 3 mm, less than or equal to 2 mm, or less than or equal to 1 mm;
the gap is greater than or equal to 0.3 mm, greater than or equal to 0.5 mm, greater than or equal to 0.75 mm, or greater than or equal to 0.85 mm;

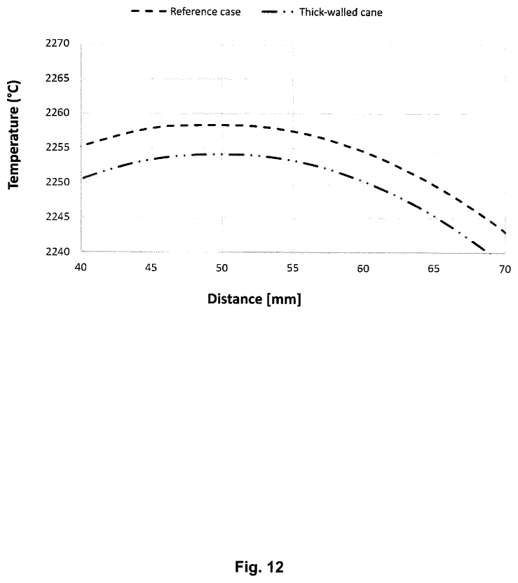

FIG. 12 shows the results of simulations of the temperature distribution in anti-resonance units 300 of a fiber assembly 100. For the numerical calculations, a P1 radiation model was used for radiative heat transfer in a semitransparent medium and the ray-shooting method for radiation on a semitransparent surface.

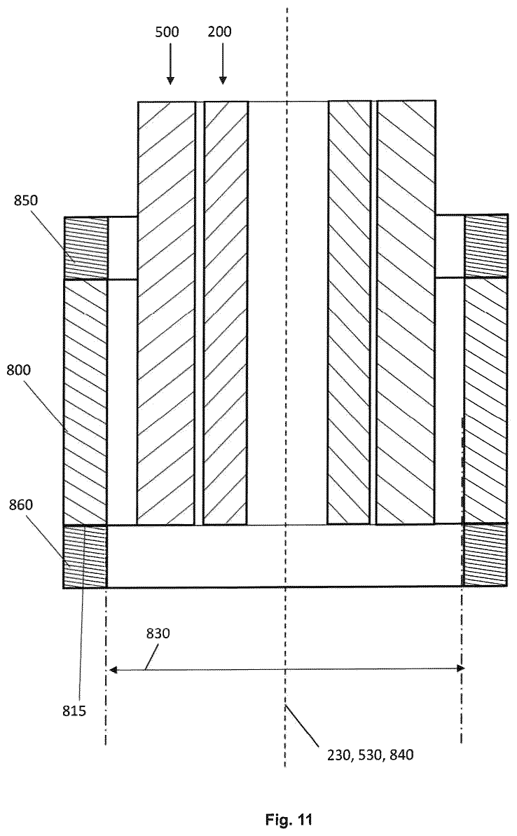

The starting point for the simulations was the fiber assembly 100, comprising a jacket tube 500 and a hollow-core assembly 400. FIG. 11 illustrates the arrangement of the elements: oven 800, jacket tube 500 and sheath tube 200. In the simulation, the fiber assemblies 100 had a jacket tube length of 210 mm and sheath tube length that was just as long.

The sheath tube 200, the jacket tube 500 and the oven 800 are aligned with each other such that the jacket tube longitudinal axis 530, the sheath tube longitudinal axis 230 and an oven longitudinal axis 840 are congruent. The oven 800 has an oven height of 820 of 120 mm and an inner diameter 830 of 35 mm. The oven is connected at its ends to an upper contact region 850 and a lower contact region 860. These are passively designed and do not generate heat.

During the simulations, the fiber assembly 100 was positioned in such a way that the lower end of the sheath tube 400 and the jacket tube 500 terminate at the lower end 815 of the oven 800, which is also illustrated in FIG. 11. The fiber assembly 100 was fed into the electric oven 800 at a feed rate of 8 mm/min during the drawing step 3600. The initial temperature of fiber assembly 100 was 20° C.

A Gaussian-like temperature profile was assumed along the oven height 820 so that the maximum temperature was in the center of the oven 800. The temperature distribution along the sheath tube inner face 215 was calculated.

| | | Fiber |
|---|---|---|
| | Comparison | arrangement |
| | measurement | 100 |
| | (mm) | (mm) |
| Ratio of the jacket tube cross- | 65.5 | 13.2 |
| sectional area 550 to the sheath | | |
| tube cross-sectional area 450 | | |
| Jacket tube diameter 512 | 28 | 28 |
| Jacket tube inner diameter 513 | 7 | 9.6 |
| Wall thickness 511 of the jacket | 10.5 | 9.2 |
| tube wall 510 | | |
| Size 610 of the gap 600 | 0.25 | 0.25 |
| Sheath tube diameter 212 | 6.5 | 9.13 |
| Sheath tube inner diameter 213 | 5.57 | 5.57 |
| Wall thickness 211 of the sheath | 0.47 | 1.78 |
| tube wall 210 | | |

In FIG. 12, the temperature along the sheath tube inner face 215 is plotted against a distance to an oven underside 815. The following are plotted:
results marked with dots for a fiber assembly in which the ratio of the jacket tube cross-sectional area 550 to the sheath tube cross-sectional area 450 lies outside the interval [5; 40], and the
results marked with dash-dots for the fiber assembly 100 in which the ratio of the jacket tube cross-sectional area 550 to the sheath tube cross-sectional area 450 lies within the interval [5; 40].

It can be seen that a reduction in the temperature at the sheath tube inner face 215 is achieved when the ratio of the jacket tube cross-sectional area 550 to the sheath tube cross-sectional area 450 lies within the interval [5; 40].

As FIG. 11 illustrates, the calculated temperature of the fiber assembly 100, whose ratio of the jacket tube cross-sectional area 550 to the sheath tube cross-sectional area 450 lies within the interval [5; 40], is approximately 5° C. below the temperature that is achieved on the sheath tube inner face 215 when the ratio of the jacket tube cross-sectional area 550 to the sheath tube cross-sectional area 450 lies outside the interval [5; 40].

This seemingly small temperature difference has a major impact on the actual production of anti-resonant hollow-core fibers. Small changes in the viscosity of the anti-resonance unit, in particular the ARU inner tubes, often result in variations in the geometric shape. These fluctuations, which can occur during drawing, lead to deviations in the geometry of the anti-resonant hollow-core fiber from the desired fiber profile. However, even small deviations from the desired fiber profile often lead to a non-linear increase in attenuation. Accordingly, even the smallest deviations from the desired fiber profile have strong consequences. Therefore, the disclosed way of reducing the temperature on the sheath tube inner face 215 significantly increases the attenuation of the drawn anti-resonant hollow-core fiber.

### REFERENCE SIGNS

100, 100′ Fiber assembly of an anti-resonant hollow-core fiber
200 Sheath tube
210 Sheath tube wall
211 Wall thickness of the sheath tube 200
212 Sheath tube diameter
213 Sheath tube inner diameter
215 Sheath tube inner face
216 Sheath tube outer face
220 Sheath tube inner bore
230 Sheath tube longitudinal axis
300 Anti-resonance unit (ARE)
310 ARU outer tube
311 Longitudinal axis
315 ARU outer unit wall
317 Interior of the ARU outer unit
340 ARU inner tube
345 ARU inner unit wall
370, 370′ Connection seam
400 Hollow-core assembly
450 Sheath tube cross-sectional area
500 Jacket tube
510 Jacket tube wall
511 Wall thickness of the jacket tube 500
512 Jacket tube diameter
513 Jacket tube inner diameter
515 Jacket inner face
516 Jacket outer face
520 Jacket tube inner bore
530 Jacket tube longitudinal axis
550 Jacket tube cross-sectional area
600 Gap
610 Radial size of the gap
800 Oven
805 Spatial zone
810 Movement arrow
815 Lower end of the oven 800
820 Oven height
830 Inner diameter of the oven
840 Oven longitudinal axis
850 Upper contact region
860 Lower contact region
1000 Anti-resonant hollow-core fiber
1200 Fiber sheath tube
1215 Inner surface
1300 Fiber anti-resonance unit
1310 Fiber ARU outer tube
1340 ARU inner tube in the fiber
1500 Fiber jacket tube
2310 Core radius
2300 Longitudinal axis
2320 Hollow core
3000 Providing a sheath tube
3100 Preparing a number of anti-resonance units
3200 Inserting
3300 Creating a hollow-core assembly
3400 Preparing a jacket tube
3500 Introducing
3600 Drawing the hollow-core fiber

What is claimed is:

1. A method for producing an anti-resonant hollow-core fiber having an outer diameter of less than 500 mm, comprising the steps of:
providing a sheath tube, which comprises a sheath tube inner bore and a sheath tube longitudinal axis along which a sheath tube wall extends, the sheath tube wall being delimited by a sheath tube inner face and a sheath tube outer face;
preparing a number of anti-resonance units, each comprising an ARU outer tube;
inserting at least parts of the anti-resonance units into the sheath tube inner bore;
creating a hollow-core assembly comprising the sheath tube and the anti-resonance units by at least partially connecting the anti-resonance units to the sheath tube inner face;
preparing a jacket tube, which comprises a jacket tube inner bore and a jacket tube longitudinal axis along which a jacket tube wall extends, the jacket tube wall being delimited by a jacket inner face and a jacket outer face; and,
introducing at least parts of the hollow-core assembly into the jacket tube inner bore, drawing the hollow-core fiber from the jacket tube and the hollow-core assembly by means of a hot-forming process, wherein in the step of drawing the hollow-core fiber the sheath tube has a sheath tube diameter of at least 8 mm, the jacket tube has a jacket tube diameter of at least 25 mm, and a ratio of a jacket tube cross-sectional area of the jacket tube wall to a sheath tube cross-sectional area of the sheath tube wall lies within the interval.

2. The method for producing an anti-resonant hollow-core fiber according to claim 1, wherein the ratio of the jacket tube cross-sectional area to the sheath tube cross-sectional area has at least one of the following features:
it is less than or equal to 3, in particular less than or equal to 35, in particular less than or equal to 30; and,
it is greater than or equal to 9, in particular greater than or equal to 12, in particular greater than or equal to 15, in particular greater than or equal to 20.

3. The method for producing an anti-resonant hollow-core fiber according to claim 1, wherein the sheath tube has at least one of the following features:
the sheath tube diameter is less than or equal to 100 mm, less than or equal to 90 mm, less than or equal to 75 mm, less than or equal to 50 mm;
the sheath tube diameter is greater than or equal to 10 mm, greater than or equal to 15 mm, greater than or equal to 20 mm;
the sheath tube wall has a wall thickness of more than 2 mm, more than 3 mm, more than 5 mm, more than 7.5 mm;
the sheath tube wall has a wall thickness of less than 25 mm, less than 20 mm, less than 15 mm;
the sheath tube has a sheath tube length of at least 1 m; and,
a magnitude of the wall thickness of the sheath tube wall varies over the sheath tube length by less than 10%, in particular 5%, in particular 3% of the wall thickness.

4. The method for producing an anti-resonant hollow-core fiber according to claim 1, wherein the at least partial connecting of the anti-resonance units to the sheath tube inner face comprises at least one of the following features:
connecting in a second hot-forming process, in particular selected from at least one of elongating and collapsing;
integrally connecting the anti-resonance units to the sheath tube inner face along a connection seam; and,
integrally connecting, at points, the anti-resonance units to parts of the sheath tube inner face.

5. The method for producing an anti-resonant hollow-core fiber according to claim 1, wherein the jacket tube has at least one of the following features:
the jacket tube diameter is less than or equal to 290 mm, in particular less than or equal to 220 mm, in particular less than or equal to 180 mm, in particular less than or equal to 150 mm;
the jacket tube diameter is greater than or equal to 50 mm, in particular greater than or equal to 60 mm, in particular greater than or equal to 75 mm, in particular greater than or equal to 85 mm;
the jacket tube wall has a wall thickness of more than 15 mm, in particular more than 20 mm, in particular more than 30 mm, in particular more than 40 mm;
the jacket tube wall has a wall thickness of less than 90 mm, in particular less than 80 mm, in particular less than 70 mm, in particular less than 60 mm;
the jacket tube has a jacket tube length of at least 1 m; and,
a magnitude of the wall thickness of the jacket tube wall varies over the jacket tube length by not more than 10%, in particular 5%, in particular 3% of the wall thickness.

6. The method for producing an anti-resonant hollow-core fiber according to claim 1, wherein the sheath tube length and the jacket tube length, in particular the sheath tube length, the jacket tube length and a length of the anti-resonance units, differ by not more than 15%, in particular 10%, in particular 5%, relative to the jacket tube length.

7. The method for producing an anti-resonant hollow-core fiber according to claim 1, wherein the method has at least one of the following features:
a magnitude of the sheath tube cross-sectional area of the sheath tube wall varies over the sheath tube length by not more than 10%, in particular 5%, in particular 3%;
a magnitude of the jacket tube cross-sectional area of the jacket tube wall varies over the jacket tube length by not more than 10%, in particular 5%, in particular 3%; and,
a magnitude of the ratio of the jacket tube cross-sectional area to the sheath tube cross-sectional area varies over the jacket tube length by not more than 10%, in particular 5%, in particular 3%, relative to the jacket tube cross-sectional area.

8. The method for producing an anti-resonant hollow-core fiber according to claim 1, wherein the method does not comprise any hot-forming process steps between the step of introducing and the step of drawing.

9. The method for producing an anti-resonant hollow-core fiber according to claim 1, wherein the method does not comprise any intermediate steps between the step of introducing and the step of drawing.

10. The method for producing an anti-resonant hollow-core fiber according to claim 1, wherein the step of drawing is performed by means of a hot-forming process selected from at least one of elongating and collapsing.

11. The method for producing an anti-resonant hollow-core fiber according to claim 1, wherein heat introduced into the jacket tube in the hot-forming process in the step of drawing is subject to at least two heat transfers during transfer between the jacket tube and the sheath tube, in particular wherein, after the step of introducing, there is a gap between the jacket tube and the hollow-core assembly, so that heat introduced into the jacket tube in particular in the hot-forming process in the step of drawing is subject to at least two heat transfers in the gap.

12. The method for producing an anti-resonant hollow-core fiber according to claim 11, wherein, when the hollow-core assembly is centrally positioned in the jacket tube inner bore, the gap has at least one of the following features:
a radial size of the gap is less than or equal to 4 mm, in particular less than or equal to 3 mm, in particular less than or equal to 2 mm, in particular less than or equal to 1 mm; and,
the radial size of the gap is greater than or equal to 0.3 mm, in particular greater than or equal to 0.5 mm, in particular greater than or equal to 0.75 mm, in particular greater than or equal to 0.85 mm.

13. The method for producing an anti-resonant hollow-core fiber according to claim 11, wherein a first heat transfer coefficient at an outer interface between the gap and the jacket inner face is [65; 180] W/(m²*K), in particular [90; 150] W/(m²*K) for 500-900° C.

14. The method for producing an anti-resonant hollow-core fiber according to claim 11, wherein a second heat transfer coefficient at an inner interface between the gap and the sheath tube outer face is [65; 180] W/(m²*K), in particular [90; 150] W/(m²*K) for 500-900° C.

15. The method for producing an anti-resonant hollow-core fiber according to claim 1, wherein the method comprises at least one of the following steps:
coating the hollow-core fiber with at least one layer, in particular a layer comprising light-curing polymer; and,
winding the hollow-core fiber onto a spool.
